(19) United States
(12) Patent Application Publication
(10) Pub. No.: US 2015/0062177 A1
(43) Pub. Date: Mar. 5, 2015

(54) METHOD AND APPARATUS FOR FITTING A TEMPLATE BASED ON SUBJECT INFORMATION

(71) Applicant: Samsung Electronics Co., Ltd., Suwon-si (KR)

(72) Inventor: Won-seok Song, Seoul (KR)

(21) Appl. No.: 14/295,620

(22) Filed: Jun. 4, 2014

(30) Foreign Application Priority Data
Sep. 2, 2013 (KR) 10-2013-0105088

(51) Int. Cl. G06T 11/60; G06T 3/60; G09G 5/14

(52) U.S. Cl. CPC G06T 11/60; G09G 5/14; G06T 3/606; G09G 2340/10; G09G 2340/12; G09G 2340/0492
USPC 345/641

(57) ABSTRACT

A method for fitting a template is described. A 2D template is selected based on user input. A subject is detected from an input image. Subject information is extracted from the input image. The subject information includes at least one of a location, a size, or an angle of the detected subject. The selected 2D template is fitted to the detected subject through a three-dimensional rotation based on the extracted subject information.

### RELATED APPLICATIONS

This application claims the benefit of Korean Patent Application No. 10-2013-0105088, filed on Sep. 2, 2013, in the Korean Intellectual Property Office, the disclosure of which is incorporated herein in its entirety by reference.

### BACKGROUND

1. Field

One or more embodiments of the present disclosure relate to a method and apparatus for fitting a template based on subject information.

2. Description of the Related Art

Recently, technology of selecting templates, such as stickers or captured images, has been widely used for capturing images with a camera.

While a conventionally used template is produced mainly with a front side of a subject as a reference, it is difficult to match a template with the subject because in many cases the image is captured with the template when the subject is not perpendicular to a front side of the camera. Even though an angle can be adjusted with a z-axis rotation, when the captured image is rotated with respect to an x-axis or y-axis (that is, distorted in a three-dimensional state), it is difficult to provide a relevant rotation.

To provide a rotation relevant to all angles in a three-dimensional state, a production of a template with three-dimensional information is required. However, such a template with three-dimensional information requires large memory usage and, subsequently, is not easy to produce.

### SUMMARY

One or more embodiments of the present disclosure include a method and apparatus for fitting a two-dimensional template by automatic three-dimensional rotation according to a rotation angle of a subject detected from the input image.

An embodiment of the present disclosure includes a method for fitting a template which enables a smooth composition of a template regardless of the angle of the subject and an automatic performance of the fitting function, and simplifies the correction work for the location, the size, and the angle of the template of a user. Also, according to an embodiment of the present disclosure, the method for fitting a template provides an operation method for a template without three-dimensional information and may be more efficient with respect to memory or processing performance.

An embodiment of the present disclosure includes a method for fitting a template. A 2D template is selected based on user input. A subject is detected from an input image. Subject information is extracted from the input image. The subject information includes at least one of a location, a size, or an angle of the detected subject. The selected 2D template is fitted to the detected subject through a three-dimensional rotation based on the extracted subject information.

According to an embodiment of the present disclosure, the subject may include a human face.

According to an embodiment of the present disclosure, the fitting of the selected 2D template may include adjusting a size of the selected 2D template based on the size of the detected subject.

According to an embodiment of the present disclosure, the fitting of the selected 2D template may include transferring a location of the selected 2D template based on the location of the detected subject.

According to an embodiment of the present disclosure, the fitting of the selected 2D template may include: transferring the selected 2D template to match a center of the selected 2D template and a center of a rotation axis; three-dimensionally rotating the selected 2D template based on the angle of the detected subject with the rotation axis as a reference; and restoring the rotated template to an original location of the selected 2D template.

According to an embodiment of the present disclosure, the three-dimensional rotation of the selected 2D template may include limiting a rotation angle for each axis of the rotation axis to more than or equal to −30 degrees and less than or equal to +30 degrees.

According to an embodiment of the present disclosure, the extracting of the subject information may include extracting values of a yaw angle, a pitch angle, and a roll angle of the detected subject. The fitting of the selected 2D template may include rotating the selected 2D template based on the extracted values of the yaw angle, the pitch angle, and the roll angle.

According to an embodiment of the present disclosure, the method may further include: displaying the fitted 2D template on a display unit; and performing a detailed fitting of the fitted 2D template based on user input.

According to an embodiment of the present disclosure, the performing of the detailed fitting may include providing a user interface for adjusting at least one of the location, the size, or the three-dimensional rotation angle of the selected 2D template.

According to an embodiment of the present disclosure, the method may further include displaying in real-time the detailed fitting of the selected 2D template based on the user input.

According to an embodiment of the present disclosure, the displaying in real-time may include displaying in real-time a rotation of the selected 2D template with a center axis as a reference based on user input. A center of the selected 2D template may be the center axis.

According to an embodiment of the present disclosure, an apparatus for fitting a template may include: a template selection unit that selects a 2D template based on user input; a subject detection unit that detects a subject from an input image; a subject information extraction unit that extracts subject information from the input image, where the subject information may include at least one of a location, a size, or an angle of the detected subject; and a template fitting unit that fits the selected 2D template to the detected subject through a three-dimensional rotation based on the extracted subject information.

According to an embodiment of the present disclosure, the subject may include a human face.

According to an embodiment of the present disclosure, the template fitting unit may include a template size adjustment unit that adjusts a size of the selected 2D template based on the size of the detected subject.

According to an embodiment of the present disclosure, the template fitting unit may include a template transfer unit that transfers the selected 2D template based on the location of the detected subject.

According to an embodiment of the present disclosure, the template fitting unit may include a template rotation unit which transfers the selected 2D template to match a center of the selected 2D template and a center of a rotation axis, three-dimensionally rotates the selected 2D template with the rotation axis as a reference based on the angle of the detected subject, and restores the three-dimensionally rotated template to an original location of the selected 2D template.

According to an embodiment of the present disclosure, the template rotation unit may limit a rotation angle of each axis of the rotation axis to more than or equal to −30 degrees and less than or equal to +30 degrees.

According to an embodiment of the present disclosure, the template fitting unit may display the fitted template on a display unit, provide a user interface, and perform a detailed fitting of the fitted 2D template based on user input.

According to an embodiment of the present disclosure, the template fitting unit may displays in real-time a rotation of the selected 2D template with a center axis as a reference based on user input. A center of the selected 2D template may be the center axis.

According to an embodiment of the present disclosure, a non-transitory computer-readable recording medium may have recorded thereon a program for executing the method of fitting a template.

Additional features will be set forth in part in the description which follows and, in part, will be apparent from the description, or may be learned by practice of the presented embodiments.

### BRIEF DESCRIPTION OF THE DRAWINGS

These and/or other embodiments will become apparent and more readily appreciated from the following description of the embodiments, taken in conjunction with the accompanying drawings in which:

FIG. 1 is a block diagram illustrating a template fitting apparatus 100 according to an embodiment;

FIG. 2 is a flowchart illustrating a method for fitting a template, according to an embodiment;

FIG. 3 illustrates rotation directions of yaw, pitch, and roll axes of a detected subject according to an embodiment;

FIGS. 4A and 4B illustrate diagrams to explain the three-dimensional rotation of a template according to an embodiment;

FIG. 5 is a flowchart illustrating a three-dimensional rotation method of a template, according to an embodiment;

FIGS. 6A-6D illustrate example diagrams of the three-dimensional rotation movement of a template according to an embodiment;

FIG. 7 is a flowchart illustrating a method of fitting a template to the subject based on extracted subject information, according to an embodiment;

FIGS. 8A and 8C illustrate an image to which a template may be applied, according to an embodiment;

FIG. 8B illustrates an example of a two-dimensional template according to an embodiment;

FIG. 9 illustrates example diagrams of fitting a template, according to an embodiment;

FIG. 10 is a flowchart illustrating a method of fitting a template, according to an embodiment;

FIG. 11 illustrates user interfaces for the method of fitting a template, according to an embodiment; and

FIG. 12 illustrates a user interface for the method of fitting a template, according to another embodiment.

### DETAILED DESCRIPTION

Reference will now be made in detail to embodiments, examples of which are illustrated in the accompanying drawings, wherein like reference numerals refer to the like elements throughout. In this regard, the present embodiments may have different forms and should not be construed as being limited to the descriptions set forth herein. Accordingly, the embodiments are merely described below, by referring to the figures, to explain features of the present description. Expressions such as “at least one of,” when preceding a list of elements, modify the entire list of elements and do not modify the individual elements of the list.

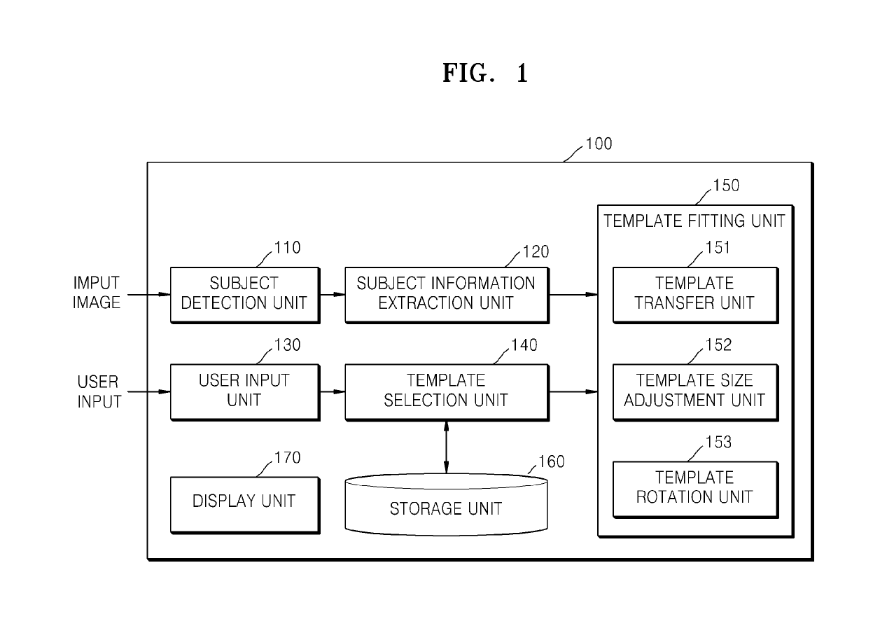

FIG. 1 is a block diagram of template fitting apparatus 100 according to an embodiment.

The template fitting apparatus 100 illustrated in FIG. 1 illustrates only one embodiment of the template fitting apparatus 100. Thus, the template fitting apparatus 100 may include more of other general-purpose components as well as components illustrated in FIG. 1 according to an embodiment. Also, the template fitting apparatus 100 may include a digital camera capable of digital image processing, a digital camcorder, a smart phone, a laptop computer, or a tablet PC, but is not confined to such implementations.

Referring to FIG. 1, the template fitting apparatus 100 may include a subject detection unit 110, a subject information extraction unit 120, a user input unit 130, a template selection unit 140, a template fitting unit 150, a storage unit 160, and a display unit 170. Also, the template fitting unit 150 may include a template transfer unit 151, a template size adjustment unit 152, and a template rotation unit 153

The subject detection unit 110 may detect the subject from the input image.

For example, if the detected subject is a human face, the subject detection unit 110 may perform facial identification. The subject detection unit 110 may detect a face either on a color basis or on an edge basis. Since many descriptions regarding facial detection are known, a detailed description thereof is omitted here.

The subject information extraction unit 120 may extract one or more of the location, the size, or the angle of the subject from the detected subject.

For example, if the detected subject is a human face, the information on the location as well as the size of the face detected may be extracted. Also, the angle information of the face may be extracted based on a line connecting both eyes of the detected face and the direction of a line perpendicular to the line connecting both eyes. Various methods may be utilized for extracting the face angle, and are not be limited by the method according to an embodiment. The extracted angle information may be values of the yaw angle, the pitch angle, or the roll angle of the detected subject.

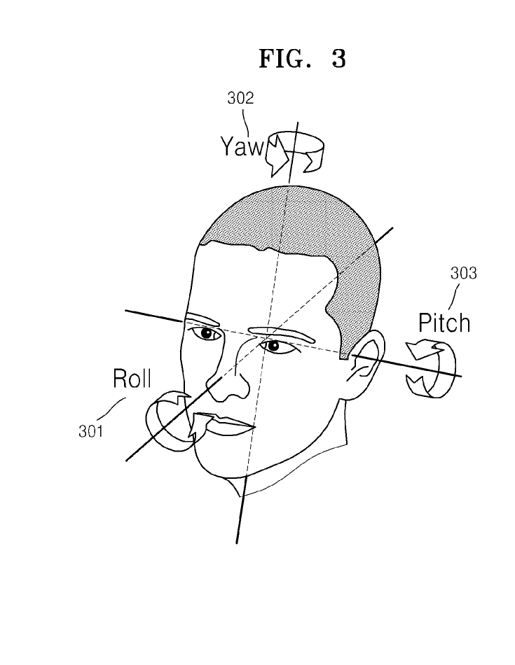

For example, FIG. 3 illustrates the rotation direction of the yaw, the pitch, and the roll of the detected subject according to an embodiment.

Referring to FIG. 3, from the rotations of the detected human face, a z-axis rotation 301 is defined as the roll, an x-axis rotation 302 is defined as the yaw, and a y-axis rotation 303 is defined as the pitch.

Referring back to FIG. 1, the user input unit 130 may include various input apparatuses, such as a touch panel or key buttons, which enable the user to enter information according to an embodiment. For example, based on user input received via the user input unit 130, one of a plurality of templates stored in the storage unit 160 may be selected, or the fitting operation may be performed to the subject by fine adjustment of the selected template.

The template selection unit 140 may select one of a plurality of templates stored in the storage unit 160 based on the user input received by the user input unit 130. The template may include images which may be composed for pictures such as a wig, an accessory, clothes, make-up, and stickers.

The template fitting unit 150 may perform the fitting of the selected template to the detected subject through three-dimensional rotation based on the extracted subject information according to an embodiment.

For example, the template fitting unit 150 may three-dimensionally rotate the template by a value of the yaw angle, the pitch angle, and the roll angle of the detected subject according to one or more embodiments.

In detail, the template transfer unit 151 may transfer the location of the template based on the location of the subject according to an embodiment. Also, the template size adjustment unit 152 may adjust the size of the template based on the size of the subject (e.g., based on the extracted subject information).

For example, if the template is a wig and the subject is a face, the template size adjustment unit 152 may adjust the size of the wig based on the size of the detected face. For example, the face area detected from the image may be defined as a first area, the area including the overall wig template may be defined as a second area, and the area where the face is to be located in the wig template may be defined as a third area. The size of the second area may be adjusted at a substantially constant ratio while maintaining sizes of the first area and the third area the same. Here, the second area may be a pre-selected area when the face exists at the time of template production.

Also, the template transfer unit 151 may transfer the size-adjusted wig to the location of the face. For example, the area on the wig image where the face may be located (e.g., the third area) and the face area (e.g., the first area) may be matched. For example, the template transfer unit 151 may match the center of the first area and the center of the third area according to an embodiment.

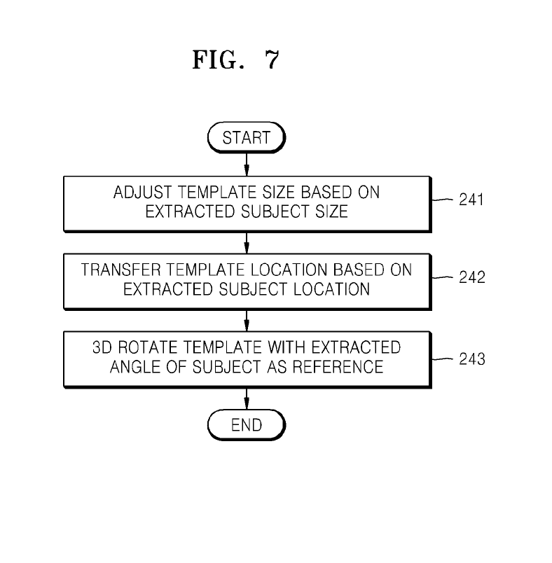

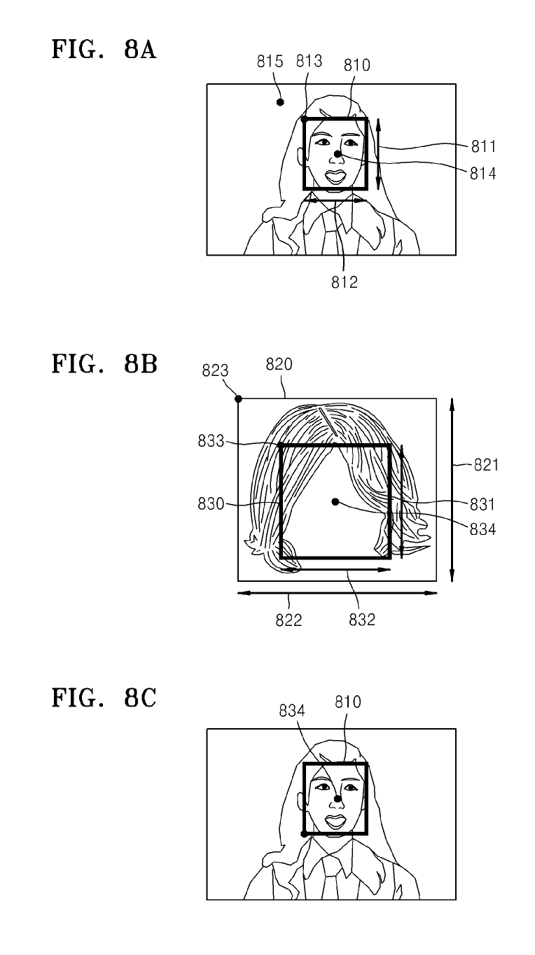

In another example, the method of changing the size and the location of the template for fitting the template based on the subject information is explained in detail with reference to FIGS. 7 through 8 with pictures as references.

The template rotation unit 153 may three-dimensionally rotate the template with central axes as references, based on the subject information.

In detail, the template rotation unit 153 may transfer the selected template in such a way that the center of the selected template matches with the center of a rotation axis, three-dimensionally rotate the transferred template with the rotation axis as a reference according to the angle of the subject, and restore the three-dimensionally rotated template to the original location. The template may be rotated with the central axis as a reference before the template is rotated with the rotation axis as a reference, with additionally performing a transferring process of the template to the rotation axis.

As another example, if the subject is a human face, the rotation angle during the three-dimensional rotation may be limited between −30 degrees and +30 degrees for each axis because there is a limit to the angle in which the human face is typically rotated. Accordingly, if the angle for the template rotation exceeds between −30 degrees and +30 degrees, the angle of the detected face may be concluded as having an error. Thus, with stopping the rotation at the critical value, the template may be ideally fitted to the subject.

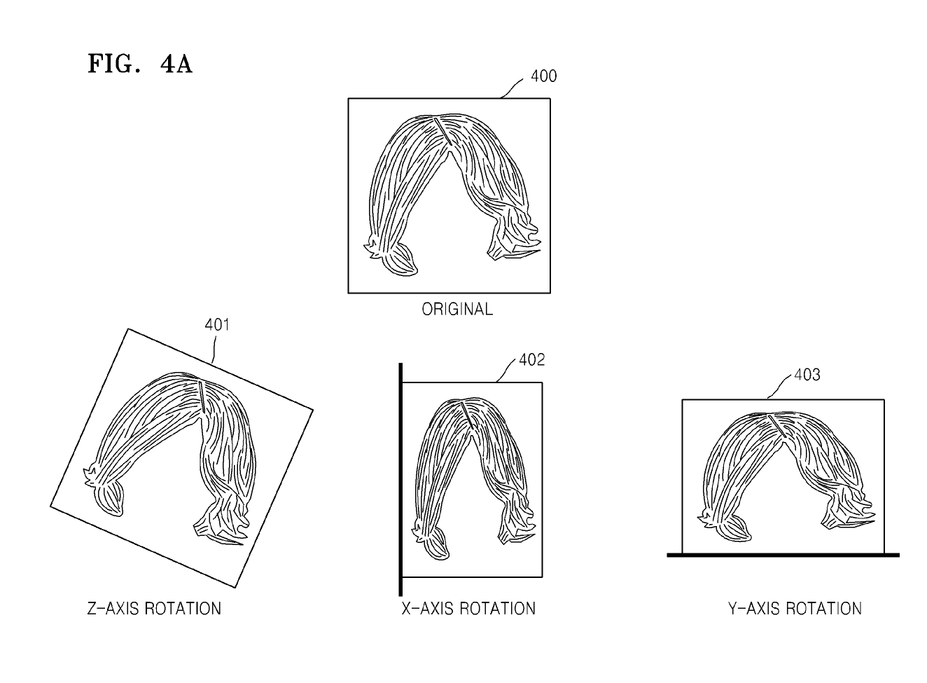

As yet another example, the three-dimensional rotation method with the central axis as a reference, through transferring the selected template to the rotation axis based on the extracted subject information, is explained in detail with reference to FIGS. 4 through 6 with pictures as references according to an embodiment.

The template fitting unit 150 may display the fitted template on the display unit 170 according to an embodiment. Also, the template fitting unit 150 may store a composed image of the picture and the fitted template to the storage unit 160 according to another embodiment.

The storage unit 160 may include a non-volatile, non-transitory storage medium storing digital data, such as a hard disk drive (HDD), flash memory, or other memory as described herein. In the storage unit 160, various computer programs available for the user to utilize the subject information extraction unit 120, and information which the user manually controls may be stored. Particularly, the template selection unit 140 may store the template to be selected and the image from which the subject may be detected.

The display unit 170 may include at least one of a liquid crystal display, a thin film transistor-liquid crystal display, an organic light-emitting diode display, a flexible display, a 3D display, or an electrophoretic display according to an embodiment. Also, the display unit 170 may be provided in a touch screen type. Particularly, when the display unit 170 is provided in a touch screen type, the user may fit in detail the template displayed on the display unit 170 to the subject with touch inputs.

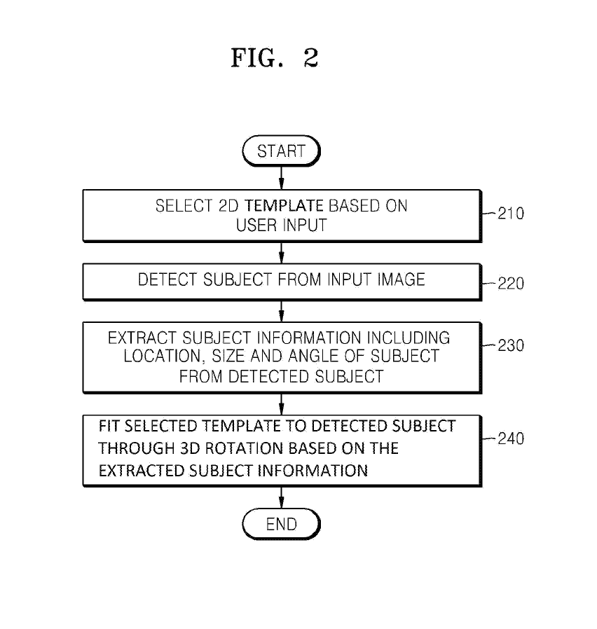

Referring to FIGS. 2 through 9, the detailed operation of the template fitting apparatus 100 is explained according to an embodiment.

FIG. 2 is a flowchart of a method of fitting a template, according to an embodiment.

In operation 210, the template selection unit 140 may select a two-dimensional template based on user input according to an embodiment. To have the template selected by the user, an image onto which the template is to be composed may be displayed beforehand. Also, with displaying the two-dimensional template stored in the storage unit 160, one template may be selected based on user input.

In operation 220, the subject detection unit 110 may detect the subject from the input image. For example, if the detected subject is a human face, the subject detection unit 110 may perform facial detection. Thus, the subject detection unit 110 may detect the face based on color or detect the face based on an edge.

In operation 230, the subject information extraction unit 120 may extract the subject information including a location, a size, or an angle of the subject from the extracted subject information.

For example, if the extracted subject is a human face, the information on the location and the size of the face may be extracted based on color or an edge according to an embodiment.

In operation 240, the selected template may be three-dimensionally rotated and fitted to the detected subject based on the extracted subject information.

FIGS. 4A and 4B illustrate conceptual diagrams to explain the three-dimensional rotation of a template according to an embodiment.

First, referring to FIG. 4A, the reference numeral 400 illustrates a two-dimensional template image of a wig shape according to an embodiment. A template which is typically stored has an image facing front as illustrated; however, other orientations will be apparent to those skilled in the art.

The reference numeral 401 illustrates a template image after z-axis rotation, the reference numeral 402 after x-axis rotation, and the reference numeral 403 after y-axis rotation.

Thus, the three-dimensional rotation method may be described based on the reference numerals 401, 402, and 403, according to an embodiment.

Also, through a combination of the described basic rotations (e.g., the z-axis, x-axis, and y-axis rotations), a three-dimensionally rotated image may be obtained as illustrated in FIGS. 4A and 4B.

A general image rotation which is typically used exhibits a z-axis rotation 401 only, because the z-axis rotation establishes a center point, performs a rotation with this point as a reference, and may be widely used and easily applied.

However, since images other than frontal images are often taken in an image shooting session (e.g., a photo shoot), there are many situations when the subject detected from the image does not directly face the front of the camera. Thus, it may not be sufficient for the template fitting to perform only the z-axis rotation of the template rotation.

Therefore, provided are a method and apparatus for exhibiting a three-dimensional image after performing a three-dimensional rotation operation on a two-dimensional image according to the angle of the subject, and composing the image through fitting the rotated template to the subject according to an embodiment.

As illustrated in an image 410 of FIG. 4B, when the x-axis and the y-axis rotations, different from the z-axis rotation, are performed with the rotation axes as bases, as illustrated by the reference numerals 402 and 403 of FIG. 4A, respectively, the locations and the shapes of the image after rotations may be misaligned. For example, once the rotation of the template begins, a problem may happen where it becomes difficult to perform location control. However, the template fitting apparatus 100 according to an embodiment may solve the described problem through transferring the template to the rotation axis, performing the three-dimensional rotation, and operating a restoring movement of the composed image to the original location. As illustrated in an image 420 of FIG. 4B, an image wherein the template is three-dimensionally rotated with the center axis as a reference may be produced.

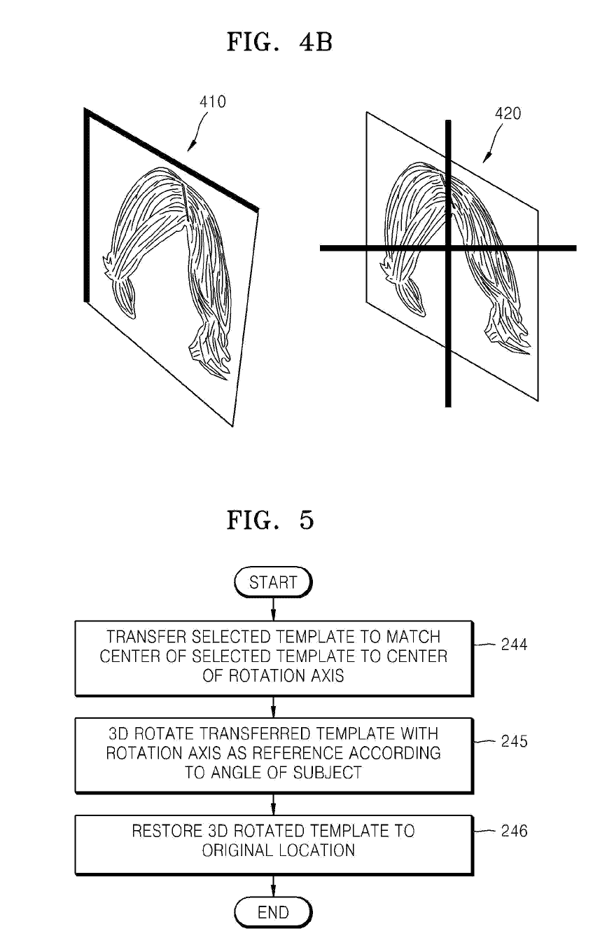

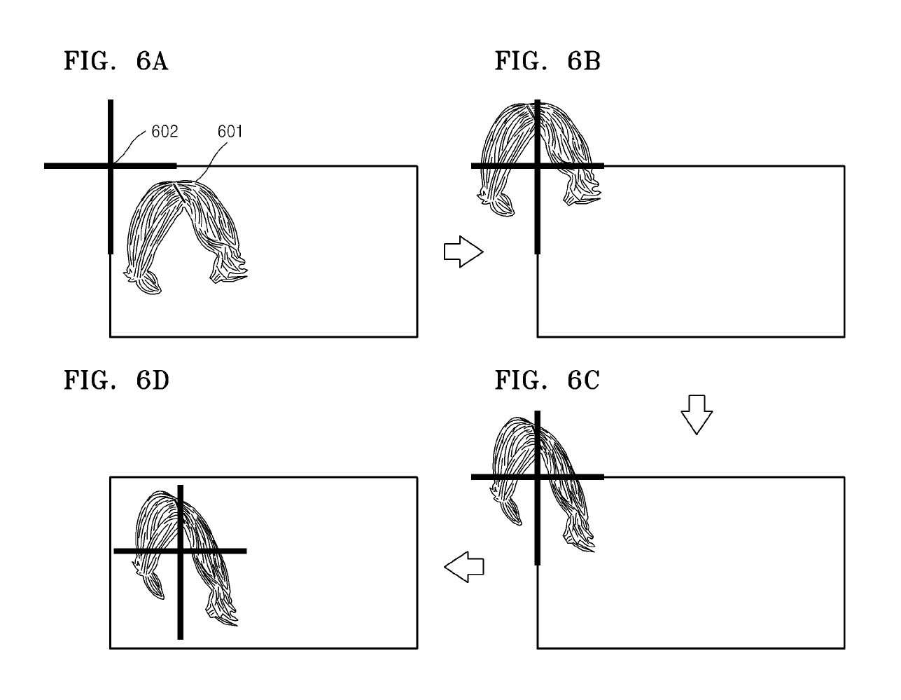

For example, FIG. 5 is a flowchart of a method of three-dimensional rotation of a template with the center axis as a reference, according to an embodiment. Also, FIG. 6 illustrates an example of a three-dimensional rotation movement of a template according to an embodiment.

Referring to FIGS. 5 and 6, in operation 244, the template fitting unit 150 may transfer a template in such a way that the center of the template matches the center of the rotation axis according to an embodiment. For example, the template may be transferred in such a way that the intersection point (0, 0, 0) of X, Y, Z axes, which are rotation axes for the three-dimensional rotation, matches the center of the template. Thus, a template 601 illustrated in FIG. 6A may be transferred to the center of a rotation axes 602 as illustrated in FIG. 6B.

In operation 245, the template fitting unit 150 according to an embodiment may three-dimensionally rotate the transferred template with the rotation axis as a reference according to the angle of the subject. Since the center of the template is transferred to match the rotation axis 602, the template may be rotated with the center of the axes as bases. As illustrated in FIG. 6C, the template may be three-dimensionally rotated with center of axes as bases.

In operation 246, the template fitting unit 150 according to an embodiment may restore the three-dimensionally rotated template to the original location (e.g., the location of the template 601 illustrated in FIG. 6A). Thus, as illustrated in FIG. 6D, a transformation may be performed as if the template is rotated with the center of axes as bases at the original location.

Therefore, as described above, since the location of the template is not changed by the rotation even though a two-dimensional template is three-dimensionally rotated, the three-dimensional rotation of the template with the center of axes as bases may allow for improved control of the location of the template 601. Also, the likelihood that the shape of the two-dimensional template is awkwardly distorted by the three-dimensional rotation may be reduced.

The image transformation as described above may be calculated through a matrix computation. The matrix, which is used to perform the three-dimensional transformation according to an embodiment, is as follows:

$$\begin{matrix}{R}_{x} ( θ ) = [ \begin{matrix}1 & 0 & 0 \\ 0 & cos θ & - sin θ \\ 0 & sin θ & cos θ\end{matrix} ] \\ {R}_{y} ( θ ) = [ \begin{matrix}cos θ & 0 & sin θ \\ 0 & 0 & 0 \\ - sin θ & 0 & cos θ\end{matrix} ] \\ {R}_{z} ( θ ) = [ \begin{matrix}cos θ & - sin θ & 0 \\ sin θ & cos θ & 0 \\ 0 & 1 & 1\end{matrix} ] & [ Mathematical Formula 1 ] \\ [ \begin{matrix}1 & 0 & {t}_{x} \\ 0 & 1 & {t}_{y} \\ 0 & 0 & 1\end{matrix} ] & [ Mathematical Formula 2 ]\end{matrix}$$

At first, for the movement of transferring the template to the rotation axis and restoring the template to the original location, the matrix of [Mathematical Formula 1] defined above may be used, and for the movement of three-dimensional rotation of the template along the rotation axis, the matrix of [Mathematical Formula 2] defined above may be used. The method of simple rotation or transfer of an image by using matrices is widely known, and thus, a detailed description thereof is omitted.

FIG. 7 is a flowchart of a method of fitting the template to the subject based on the subject information.

Referring to FIG. 7, in operation 241, the template size adjustment unit 152 according to an embodiment may change the size of the template above based on the size of the subject (e.g., based on the extracted subject information).

For example, FIG. 8A illustrates an image to which a template will be applied, according to an embodiment. Also, FIG. 8B illustrates an example of a two-dimensional template according to an embodiment.

Referring to FIGS. 8A and 8B, a case wherein the subject is a face and the template is a wig according to an embodiment is exhibited for ease of understanding. However, the combination is not limited to this case.

In FIG. 8A, a height 811 of a face detection area 810 is defined as FD_height, a width 812 is defined as FD_width, and x and y coordinates of a point 813, which indicates a location of the face detection area 810, are defined as FD_x and FD_y, respectively.

A height 821 of a template 820, which has a wig image, as illustrated in FIG. 8B, is defined as Template_height, a width 822 is defined as Template_width, and x and y coordinates of a point 833 which indicates the location of the template 820 when the template 820 is exhibited in the image, are defined as Template_x and Template_y, respectively.

Also, the template 820 illustrated in FIG. 8B may include an area 830 where the detected face is to be located. The area 830, where the detected face is to be located, is an area where the template 820 is generally “aesthetically fitted” to the subject and may be an area which a template designer may empirically or experimentally determine.

A height 831 of the area 830, where the face is to be located, is defined as WS_height, a width 832 is defined as WS_width, and x and y coordinates of the point 833, which indicates the location of the area where the face is to be located when the template is exhibited in the image, are defined as WS_x and WS_y, respectively.

Then, according to [Mathematical Formula 3] below, size adjustment ratios for a template may be obtained.

Ratio_width=FD_width/WS_width

Ratio_height=FD_height/WS_height [Mathematical Formula 3]

Also, the template size adjustment unit 152 according to an embodiment may adjust the size of the template through [Mathematical Formula 4] below.

Template_height=Template_height*Ratio_height

Template_width=Template_width*Ratio_width [Mathematical Formula 4]

Referring back to FIG. 7, in operation 242, the template transfer unit 151 according to an embodiment may transfer the location of the template 820 above with the location of the extracted subject as a basis.

For example, referring to FIGS. 8A and 8B, the template transfer unit 151 according to an embodiment may transfer the template 820, which is resized and rotated to match the face detection area 810.

When the template 820 is transferred for the template fitting, a template location 823 may be transferred to a specific location to match the area 830 where the detected face is to be located and the face detection area 810. However, since the size of the template 820 is different from the face detection area 810, a simple transfer of the template location 823 to the location 813 of the face detection area 810 may not result in matching the face detection area 810 and the area 830 where the face is to be located.

Therefore, according to an embodiment, if the template 820 is transferred to a location 815 (Scaled_Template_x, Scaled_Template_y) which is scaled by ratios (Ratio_width, Ratio_height) of the area 830 where the face is to be located after the size of the template 820 and the size in operation 241 are adjusted, or by ratios (Ratio_width, Ratio_height) of the face area 810, a composed image wherein the template 820 is appropriately fitted may be obtained.

As another example, the template transfer unit 150 may transfer the template 820 in such a way that a center location 814 of the detected face matches a center location 834 of the area 830 where the face of the composed image is to be located.

The center location 814 of the face area 810 is utilized to transfer the template 820 for efficient placement of the template 820, because even if the face is rotated, the center location 814 of the face area does not move.

For example, as illustrated in FIG. 8C, even if the face area 810 is rotated by 90 degrees, the center of the face 814 is in a same position. Therefore, after the template 820 is transferred to match the center location 834 of template 820 and the center location 814 of face, there is an advantage that the fitting is based on only the three-dimensional rotation of the template. Also, there is another advantage that a ratio calculation is not needed for fitting the template to the face area.

The center coordinates of the center location 834 of the template 820 to be transferred to match the face area 810 may be obtained by the [Mathematical Formula 5]:

Scaled_Center_{—}WS_{—}x=(WS_{—}x+(WS_width/2))*Ratio_width

Scaled_Center_{—}WS_{—}y=(WS_{—}y+(WS_height/2))*Ratio_height [Mathematical Formula 5]

The center location 834 of the template in the [Mathematical formula 5] above may be determined as the center of the area 830 where the face is to be located.

Also, by matching the center location 834 of the template obtained above with the center location 814 of the face according to [Mathematical Formula 6] below, the template 820 may be fitted to the face area 810.

FD_{—}x+FD_width/2=Scaled_Center_{—}WS_{—}x

FD_{—}y+FD_height/2=Scaled_Center_{—}WS_{—}y [Mathematical Formula 6]

Referring back to FIG. 7, in operation 243, the template rotation unit 153 according to an embodiment may perform a three-dimensional rotation of the template 820 along center axes based on the extracted subject information. Since the operation 243 is explained in detail in the description with reference to FIG. 5, a description thereof is omitted.

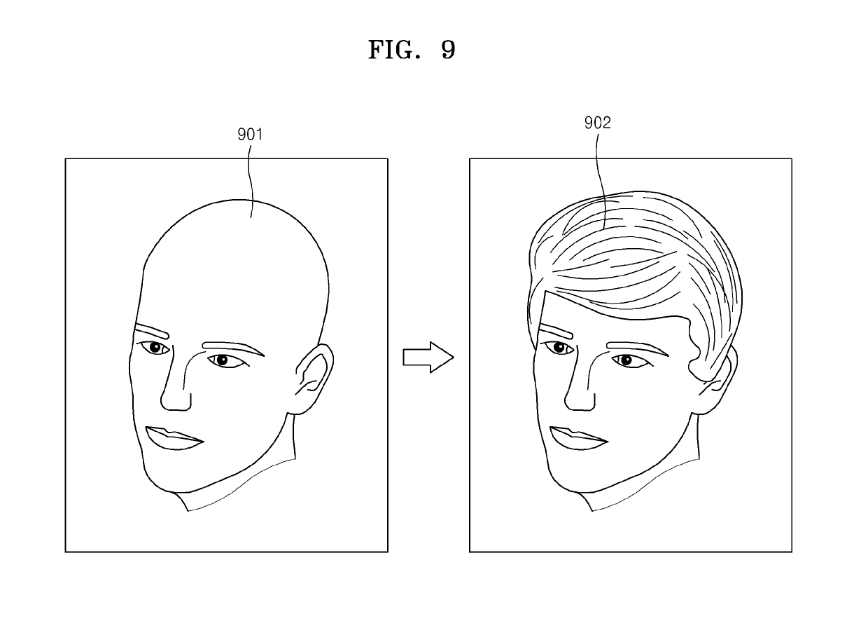

FIG. 9 illustrates a template fitting method according to an embodiment.

Referring to FIG. 9, the template fitting apparatus 100 allows a natural fitting of a template 902 (e.g., a wig), regardless of an angle of a subject 901. Also, the template fitting apparatus 100 provides a method of performing a three-dimensional rotation on a template without three-dimensional information, which may be more efficient with respect to memory or processing performance.

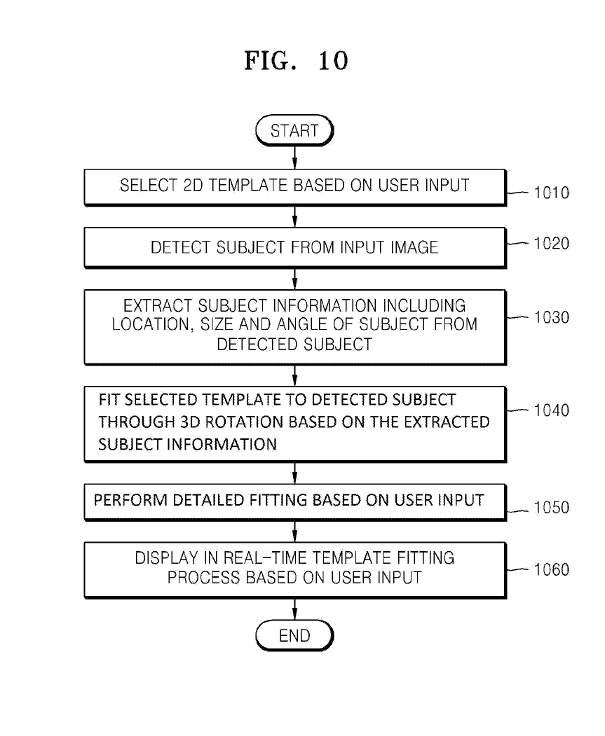

FIG. 10 is a flowchart of a method of fitting a template, according to an embodiment.

In FIG. 10, since operations 1010 through 1040 correspond to operations 210 through 240 in FIG. 2, a detailed description thereof is omitted.

Referring to FIG. 10, in operation 1050, the template fitting unit 150 according to an embodiment may perform a more detailed fitting of the template based on user input. For example, after the template fitting apparatus 100 automatically performs the fitting of the template according to operations 1010 through 1040, the template fitting unit 150 may adjust at least one of the location, the size, and the three-dimensional rotation angle of the template based on user input.

The method described above in FIG. 5 may be applied when the three-dimensional rotation angle of the template is adjusted based on user input. For example, when the template is three-dimensionally rotated based on user input, the movements of transferring to the rotation axis and restoring to the original location may be internally performed. Thus, the location of the template may not be changed during the three-dimensional rotation, and the shape of the template is less likely to be distorted.

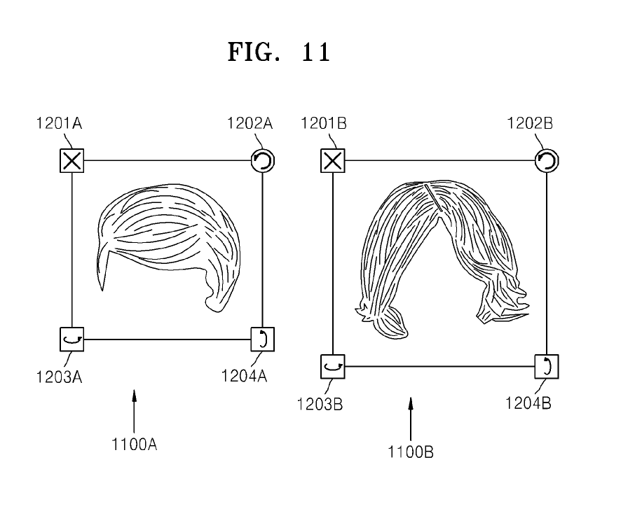

Also, for a fine or more detailed adjustment of the location, the size, and the three-dimensional rotation angle based on user input, an intuitive user interface, as illustrated in FIG. 11, may be provided.

FIG. 11 illustrates a method of providing a user interface in a method of fitting a template, according to an embodiment.

Referring to FIG. 11, intuitive user interfaces 1100A and 1100B include respective wig deletion buttons 1201A and 1201B, Z-axis rotation buttons 1202A and 1202B, X-axis rotation buttons 1203A and 1203B, and Y-axis rotation buttons 1204A and 1204B for the user to perform the fine adjustment or fitting of the image after the template fitting apparatus 100 has performed a fitting, according to an embodiment.

Referring back to FIG. 10, in operation 1060, the template fitting unit 150 according to an embodiment may exhibit a real-time display of the fitting process of the template based on user input.

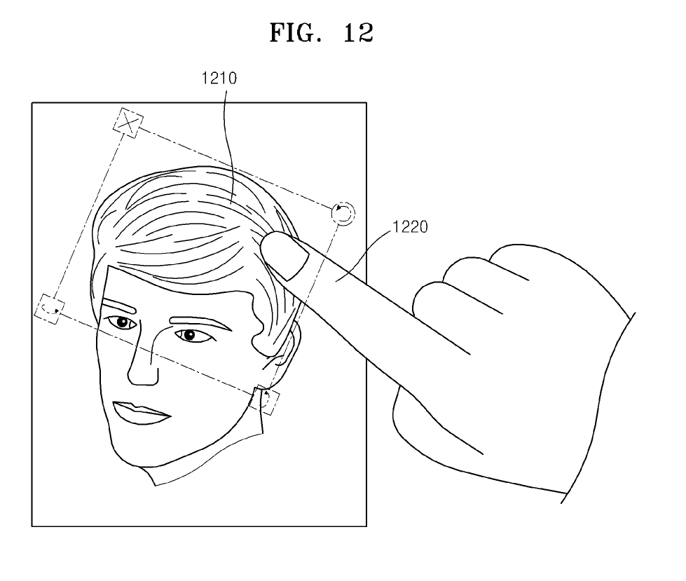

For example, FIG. 12 illustrates a user interface for fitting a template, according to another embodiment.

Referring to FIG. 12, the location, the size, and the rotation of a template 1210 (e.g., a wig template) fitted by the template fitting apparatus 100 according to an embodiment may be adjusted based on user input.

Since the template fitting apparatus 100 according to an embodiment may be rotated by a user 1220 with the center of the template 1210 as the center axis, the location or the shape may be controlled without misalignment. Since the explanation on the rotation movement of a template with a central axis as a reference is provided above with reference to FIG. 5, it is omitted.

Also, the process of three-dimensional rotation of the template 1210 may be displayed to the user in real-time based on user input.

As described above, a template fitting method according to an embodiment may automatically perform the fitting movement regardless of the angle of the subject and further provide to the user an intuitive user interface, and simplify the correction process of the user for the location, the size, and the angle of a template.

All references, including publications, patent applications, and patents, cited herein are hereby incorporated by reference to the same extent as if each reference were individually and specifically indicated to be incorporated by reference and were set forth in its entirety herein.

The apparatus described herein may comprise a processor, a memory for storing program data to be executed by the processor, a permanent storage such as a disk drive, a communications port for handling communications with external devices, and user interface devices, including a display, touch panel, keys, buttons, etc. When software modules are involved, these software modules may be stored as program instructions or computer readable code executable by the processor on a non-transitory computer-readable media such as magnetic storage media (e.g., magnetic tapes, hard disks, floppy disks), optical recording media (e.g., CD-ROMs, Digital Versatile Discs (DVDs), etc.), and solid state memory (e.g., random-access memory (RAM), read-only memory (ROM), static random-access memory (SRAM), electrically erasable programmable read-only memory (EEPROM), flash memory, thumb drives, etc.). The computer readable recording media may also be distributed over network coupled computer systems so that the computer readable code is stored and executed in a distributed fashion. This computer readable recording media may be read by the computer, stored in the memory, and executed by the processor.

Also, using the disclosure herein, programmers of ordinary skill in the art to which the invention pertains may easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, JAVA®, assembler, or the like, with the various algorithms being implemented with any combination of data structures, objects, processes, routines or other programming elements. Functional aspects may be implemented in algorithms that execute on one or more processors. Furthermore, the invention may employ any number of conventional techniques for electronics configuration, signal processing and/or control, data processing and the like. Finally, the steps of all methods described herein may be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device. The words “mechanism”, “element”, “unit”, “structure”, “means”, and “construction” are used broadly and are not limited to mechanical or physical embodiments, but may include software routines in conjunction with processors, etc.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

What is claimed is:

1. A template fitting method, the method comprising:
selecting a 2D template based on user input;
detecting a subject from an input image;
extracting subject information from the input image, wherein the subject information includes at least one of a location, a size, or an angle of the detected subject; and
fitting the selected 2D template to the detected subject through a three-dimensional rotation based on the extracted subject information.

2. The template fitting method of claim 1, wherein the subject includes a human face.

3. The template fitting method of claim 1, wherein the fitting of the selected 2D template comprises adjusting a size of the selected 2D template based on the size of the detected subject.

4. The template fitting method of claim 1, wherein the fitting of the selected 2D template comprises transferring a location of the selected 2D template based on the location of the detected subject.

5. The template fitting method of claim 1, wherein the fitting of the selected 2D template comprises:
transferring the selected 2D template to match a center of the selected 2D template and a center of a rotation axis;
three-dimensionally rotating the selected 2D template based on the angle of the detected subject with the rotation axis as a reference; and
restoring the rotated template to an original location of the selected 2D template.

6. The template fitting method of claim 5, wherein the three-dimensional rotation of the selected 2D template comprises limiting a rotation angle for each axis of the rotation axis to more than or equal to −30 degrees and less than or equal to +30 degrees.

7. The template fitting method of claim 1, wherein the extracting of the subject information comprises extracting values of a yaw angle, a pitch angle, and a roll angle of the detected subject;
wherein the fitting of the selected 2D template comprises rotating the selected 2D template based on the extracted values of the yaw angle, the pitch angle, and the roll angle.

8. The template fitting method of claim 1, further comprising:
displaying the fitted 2D template on a display unit; and
performing a detailed fitting of the fitted 2D template based on user input.

9. The template fitting method of claim 8, wherein the performing of the detailed fitting comprises providing a user interface for adjusting at least one of the location, the size, or the three-dimensional rotation angle of the selected 2D template.

10. The template fitting method of claim 8, further comprising displaying in real-time the detailed fitting of the selected 2D template based on the user input.

11. The template fitting method of claim 10, wherein the displaying in real-time comprises displaying in real-time a rotation of the selected 2D template with a center axis as a reference based on user input, wherein a center of the selected 2D template is the center axis.

12. An apparatus for fitting a template, the apparatus comprising:
a template selection unit that selects a 2D template based on user input;
a subject detection unit that detects a subject from an input image;
a subject information extraction unit that extracts subject information from the input image, wherein the subject information comprises at least one of a location, a size, or an angle of the detected subject; and
a template fitting unit that fits the selected 2D template to the detected subject through a three-dimensional rotation based on the extracted subject information.

13. The apparatus for fitting a template of claim 12, wherein the subject includes a human face.

14. The apparatus for fitting a template of claim 12, wherein the template fitting unit comprises a template size adjustment unit that adjusts a size of the selected 2D template based on the size of the detected subject.

15. The apparatus for fitting a template of claim 12, wherein the template fitting unit comprises a template transfer unit that transfers the selected 2D template based on the location of the detected subject.

16. The apparatus for fitting a template of claim 12, wherein the template fitting unit comprises a template rotation unit which transfers the selected 2D template to match a center of the selected 2D template and a center of a rotation axis, three-dimensionally rotates the selected 2D template with the rotation axis as a reference based on the angle of the detected subject, and restores the three-dimensionally rotated template to an original location of the selected 2D template.

17. The apparatus for fitting a template of claim 16, wherein the template rotation unit limits a rotation angle of each axis of the rotation axis to more than or equal to −30 degrees and less than or equal to +30 degrees.

18. The apparatus for fitting a template of claim 12, wherein the template fitting unit displays the fitted template on a display unit, provides a user interface, and performs a detailed fitting of the fitted 2D template based on user input.

19. The apparatus for fitting a template of claim 18, wherein the template fitting unit displays in real-time a rotation of the selected 2D template with a center axis as a reference based on user input, wherein a center of the selected 2D template is the center axis.

20. A non-transitory computer-readable recording medium having recorded thereon a program for executing the method of claim 1.
